(19) United States
(12) Patent Application Publication
(10) Pub. No.: US 2008/0010116 A1
(43) Pub. Date: Jan. 10, 2008

(54) SIMULTANEOUS INFORMATION RELEASE APPLICATION FIELD OF THE INVENTION

(76) Inventor: MARK HERSEY, Austin, TX (US)

Correspondence Address: IBM CORPORATION (RUS);c/o Rudolf O Siegesmund Gordon & Rees, LLp, 2100 Ross Avenue, Suite 2800, DALLAS, TX, 75201, US

(21) Appl. No.: 11/423,762

(22) Filed: Jun. 13, 2006

(51) Int. Cl. G06Q 30/00

(52) U.S. Cl. 705/14

(57) ABSTRACT

A Simultaneous Information Release Application (SIRA) controls the exchange of information between two or more participants via an exchange of information when the participants satisfy rules regarding mutuality. SIRA runs a questionnaire module, an offer module, and a match module.

### FIELD OF THE INVENTION

The present invention relates generally to the field of data processing and electronic negotiation. More particularly, the invention relates to simultaneous release of information in a negotiation when the parties satisfy conditions of mutuality.

### BACKGROUND OF THE INVENTION

During negotiations for complicated and expensive items, a series of information releases take place designed to conclude in a transaction. Buyers and sellers can negotiate with each other over the Internet while maintaining a certain level of anonymity. But the anonymity can inhibit negotiations if one party lacks confidence in the information provided by the other party or lacks assurances of relative privacy for information provided. Lack of confidence in the information arises when a first party provides useful information to a second party, but the first party either fails to receive information of mutual value from the second party or doubts the truthfulness of the received information. Lack of assurance of relative privacy for information arises when the first party provides information to a second party, but lacks sufficient assurance that a particular second party is sufficiently qualified, compared to other potential sources, to fulfill the first party's requirements.

Many Internet based commerce services attempt to increase participant confidence and privacy during anonymous negotiations through a series of double blind communications (at least for the initial communications). The double-blind communications can be through such media as e-mail, filling out forms on a web page, instant messaging, or voice mail. During the double-blind communication, the service acts as an escrow agent. The participants ask or answer questions which are sent to the escrow agent. The escrow agent typically immediately forwards the respective questions and responses to the other participant, or at least does so once the participant is reconnected to the service. Each communication appears to come from the agent or an alias, but not directly from the other participant. Thus, the double blind communication provides anonymity to the participants, and allows a party to submit questions to the other party and to receive responses in return.

One existing method of performing anonymous negotiation between two participants is disclosed in U.S. Pat. No. 6,574,608 (the '608 patent). The '608 patent allows participants to post anonymous messages to a message board related to the purchase of goods or services. No mutuality is required during the negotiation. Both participants choose the information they will reveal, but neither participant can influence the information revealed by other participants. Another existing method, disclosed in U.S. Pat. No. 6,629,082 (The '082 patent), allows bidders to make double blind offers to purchase securities. The '082 patent does not pass the bids on to the other party, but rather calculates a final price and allocates the securities to the bidders based on their bids. Neither the '608 patent nor the '082 patent provide for an exchange of mutually required information.

Other known systems for maintaining privacy during information exchange involve sending communications through a website. A database of questions is provided and a first user selects questions from the database. The first user then sends the chosen questions to a website which forwards the questions to a second user. The second user sends answers to the questions, along with the second user's selected questions to the website which transmits them to the first user. The first user may then send back answers to the second user's selected questions. All transmissions appear to originate from the website and the first user and second user's email addresses are not known to each other during initial exchanges. Such a method does not provide for mutuality of exchange as the first user receives the second user's responses to the first user's questions before deciding whether to respond to the second user's questions.

Without mutuality of information exchange, a negotiation can be ineffective and unfair for one party. For example, in price negotiations or bidding scenarios, a buyer may reveal willingness to pay one price for a machine, while a seller chooses not to answer the buyer's price question. Such a lack of mutuality in the information exchanged places the buyer at a disadvantage since the seller is unlikely to reveal his true asking price once he knows that the potential buyer will pay more. In situations involving bids from or to multiple parties, a party sending out multiple bids or receiving multiple bids may not want their transaction information to be revealed to an entire marketplace, and may wish to confine the information release to only those other parties which can be determined to be reasonably qualified to fulfill its requirements for an intended transaction.

Thus, the existing art allows for anonymity and price negotiation for electronic commerce, but does not allow one participant to specify what type of information should be disclosed, or to whom, in return for his or her disclosure. A need exists for a mechanism to enforce mutuality of responses in double-blind negotiations between electronic commerce participants. A need also exists for a mechanism to enforce the disclosure of information to only appropriate parties for situations involving parallel release of information to multiple parties.

### SUMMARY OF THE INVENTION

The Simultaneous Information Release Application (SIRA), that meets the needs identified above, is a program residing in a server, connected to an escrow database and to a question database, that controls the exchange of information between two or more participants via an exchange of information when the parties satisfy rules regarding mutuality. SIRA has three components: a questionnaire module, an offer module, and a match module.

Using the questionnaire module, a user accesses the question database, selects a transaction type category (the type of item and whether the user wishes to be a buyer, seller, or trader) and completes as many questions for that category as desired. Questions are accessed by selecting individual questions from a list, and then completing a question page for each of the selected questions. The completing of a question page comprises selecting questions, answering the questions, and indicating symmetry requirements, response requirements, and preferred responses. Thus the user pre-populates a questionnaire portion of the escrow database. Question page types may include types for multiple choice, integer, free form text or other more complex answering formats.

Using the offer application, a user creates an offer filter that allows the user to post an offer filter to the escrow database. The offer filter contains an offered section, a required section and a control section. In the offered section, the offer filter indicates at least one question for which the user offers to provide at least one response, and for each question, the user's choices of symmetry requirements, if any, that must be met for mutuality prior to the release of the provided responses to the question. In the required section, the offer filter presents a common set of at least one required question that must be answered for mutuality to be met for all the offered (not “required”) questions, and further, any preferred responses to each required question that the user conditions mutuality upon. These preferred responses, when required for mutuality are referred to as deal breakers. A deal breaker means that if a response is not the preferred response (or one of a group of preferred responses) to a required question, mutuality is not met and no exchange can take place.

Once the offer filter is posted to the escrow database, the match module compares the offer filter to other offer filters in the escrow database, and determines whether there is a match. When an offer filter matches another offer filter in the escrow database, a pair is established. Every such pair of offer filters are analyzed for all mutuality conditions, and for all the offered questions for which all mutuality conditions can be satisfied, the responses corresponding to the offered questions are exchanged. The exchanged responses may be answers to all of the offered questions of each filter, or it may be a subset, or it may be that no information is exchanged for that pair of filters.

### BRIEF DESCRIPTION OF DRAWINGS

The novel features believed characteristic of the invention are set forth in the appended claims. The invention itself, however, as well as a preferred mode of use, further objectives and advantages thereof, will be understood best by references to the following detailed description of an illustrative embodiment when read in conjunction with the accompanying drawings, wherein:

FIG. 1 describes a communications network with two participant computers, a simultaneous information release server, and an escrow database connected to each other by the Internet.

FIG. 2 depicts the simultaneous information release application and its components in a storage medium.

FIG. 3A is an example of a graphical user interface of the questionnaire module for a text question.

FIG. 3B is an example of the graphical user interface of the questionnaire module for an integer questions.

FIG. 3C is an example of the graphical user interface of the questionnaire module for a text question.

FIG. 3D is an example of the graphical user interface of the offer module for an offer filter.

FIG. 3E depicts an alternate offer filter.

FIG. 3F depicts an add question window.

FIG. 3G depicts a remove question window.

FIG. 4A-4B is a flowchart of the logic of the questionnaire module.

FIG. 5 is a flowchart of the logic of the offer module.

FIG. 6A is a flowchart of the logic of the match module.

FIG. 6B is a continuation of the flowchart of the logic of the match module.

FIG. 7 depicts the connections table.

FIG. 8 depicts the exchanged information table.

FIG. 9 depicts the filter table.

### DETAILED DESCRIPTION OF THE PREFERRED EMBODIMENT

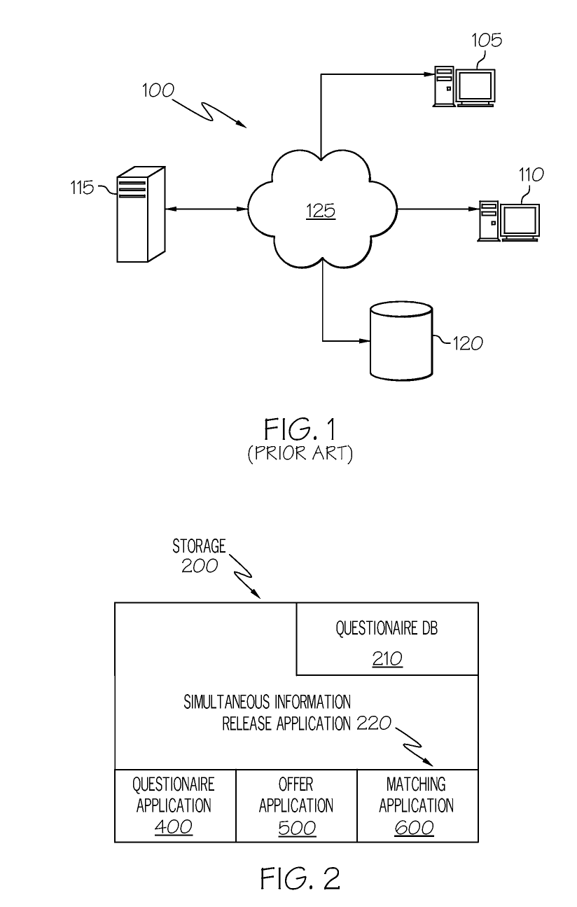

The SIRA is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

FIG. 2 depicts storage 200. In the exemplary network of FIG. 1, storage 200 may reside in persistent storage 120, or in server computer 115, or storage 200 may be distributed among elements of network 100. Storage 200 has questionnaire database 210 and simultaneous information release application (SIRA) 220. SIRA has three components: questionnaire module 400, offer module 500, and matching module 600.

Questionnaire database 210, SIRA 220, questionnaire module 400, offer module 500, and matching module 600, typically are located in storage, represented schematically as storage 200 in FIG. 2. The term “storage,” as used herein, includes without limitation any volatile or persistent medium, such as an electrical circuit, magnetic disk, or optical disk, in which a computer can store data or software for any duration. A single storage may encompass and be distributed across a plurality of media. Thus, FIG. 2 is included merely as a descriptive expedient and does not necessarily reflect any particular physical embodiment of storage 200.

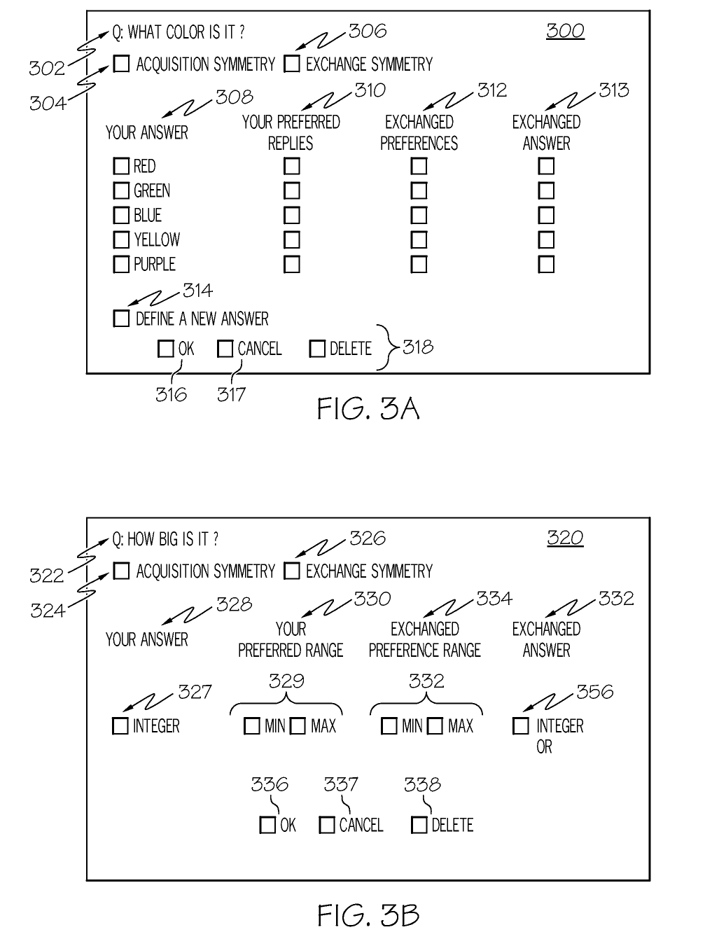

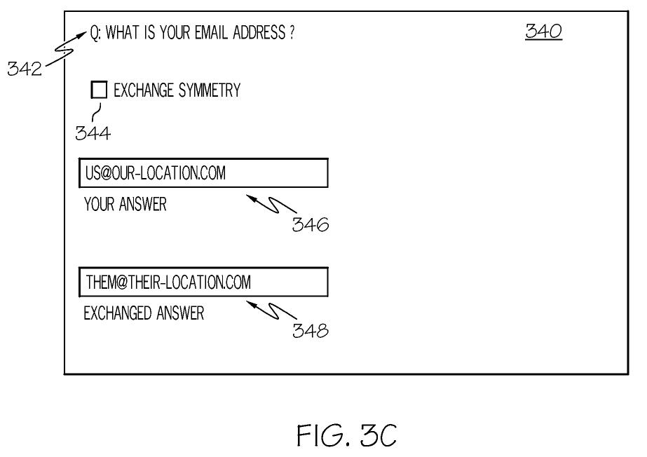

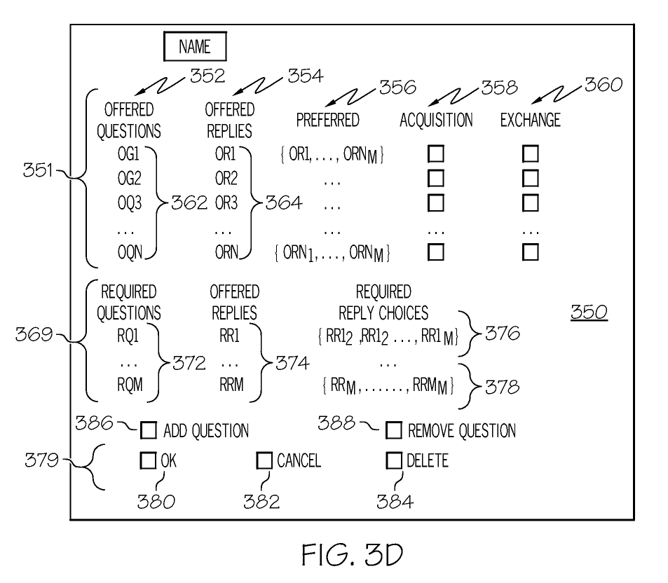

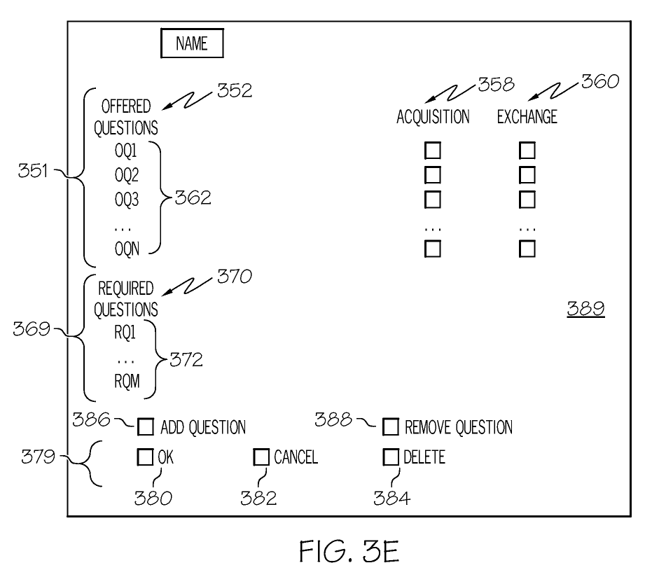

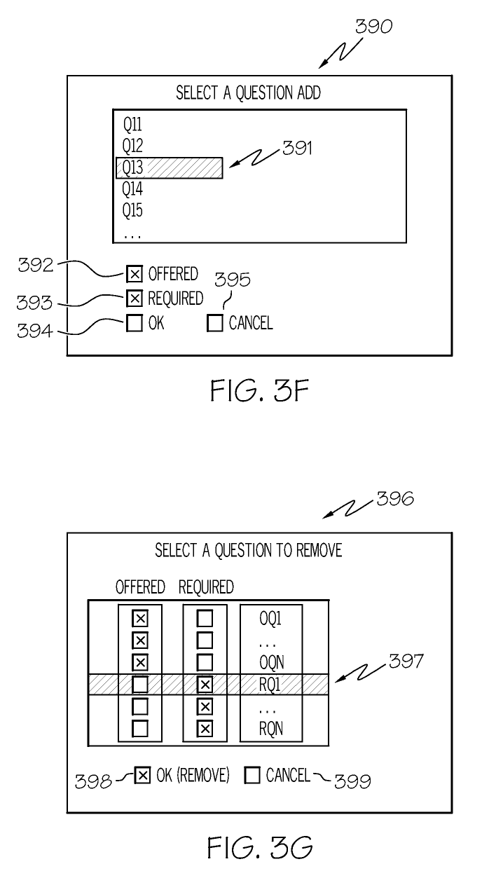

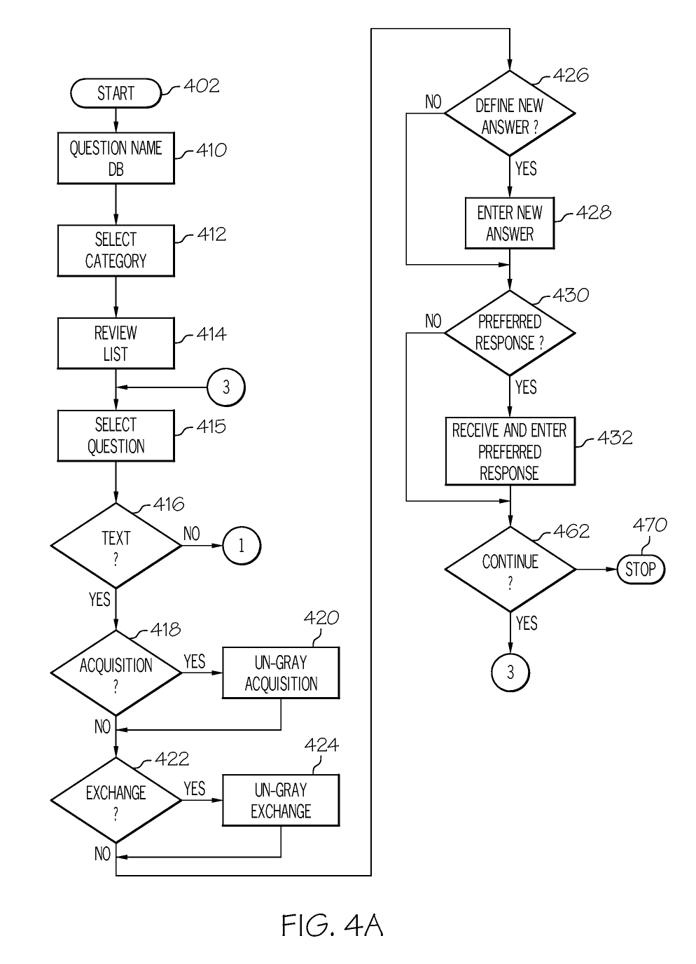

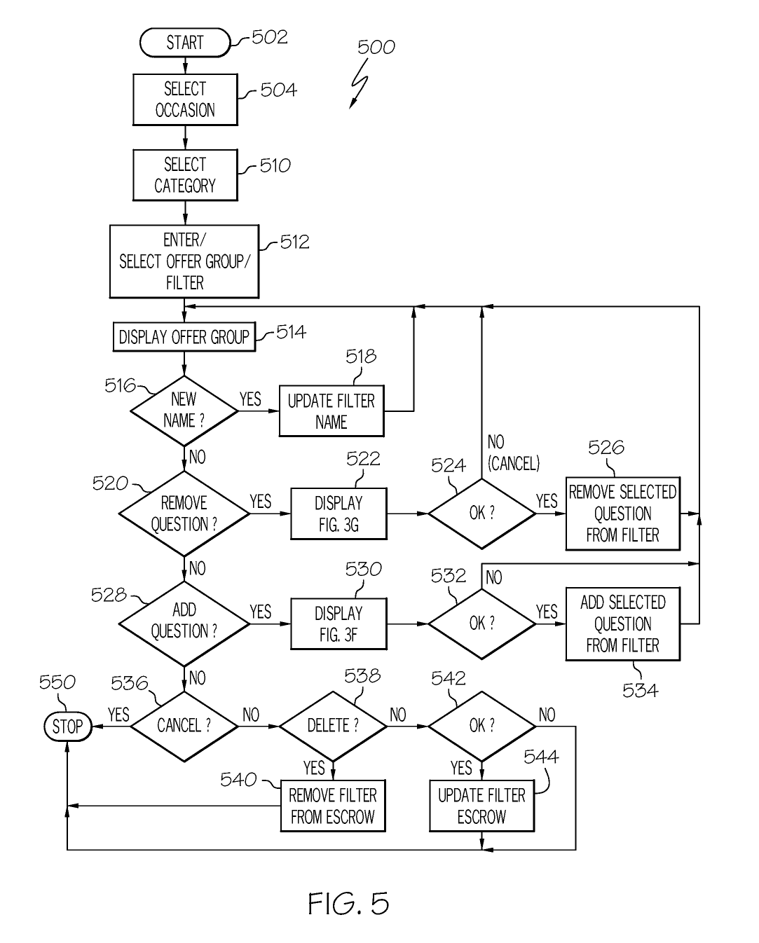

FIG. 3A-3C depicts questionnaire pages for each of the three types of questions in the questionnaire database: multiple choice, integer and free form text. FIG. 3A depicts a multiple choice question page 300 having question 302 which by way of example states “Q: what color is it?” 302. For each single question, the user may require acquisition symmetry or exchange symmetry. As used herein, acquisition symmetry means establishing response requirements where a user seeks to purchase a particular item, and exchange symmetry means establishing response requirements where a user seeks to trade one item for another. The user may elect acquisition symmetry or exchange symmetry by checking acquisition box 304 for acquisition symmetry or exchange box 306 for exchange symmetry. The user may also elect not to require symmetry and forgo checking either box. Moreover, SIRA may default/initialize the symmetries as selected for questions to discourage users from offering information too freely. A disposing user (seller or trader) may then select a multiple choice (radio button) response to the question by checking a single response under “your answer” 308. If an acquiring user (buyer or trader) has a preferred response, or a group of preferred responses, the user may check one or more “preferred” responses 310. Checking a “preferred response” and using the question as a required/deal breaker question in an offer group means that the user is requiring another user's offer group to offer the response to the question and that the escrow contains one of the preferred responses to the question. Finally, a user can select “define a new answer” 314 in which case a new screen (not shown) will be provided for the user to enter a potential new answer. The potential new answer will be forwarded for review and approval by a system administrator. Upon review and approval by an administrator, the new answer will be added to the listed responses for this question. Exchanged answer column 312 and exchanged preference column 314 may be grayed out so that they will only displayed if three conditions are met: first, that a match is made; second, that the specific question was subject to the offer; and third that information was exchanged. The user may enter the selections by checking/clicking OK button 316, cancel by checking/clicking cancel button 317, or delete the data entered by checking/clicking delete button 318.

If the user in not an acquiring user (i.e. a seller, not a buyer or trader), then the “your preferences” and “exchanged answer” are grayed out. If the user is not a disposing user (i.e. a buyer, not a seller or trader), then the “your answer and “exchanged preferences” are grayed out. If the user is not an exchanging user (trader), then the exchange symmetry option is grayed out. Depending on the implementation purposes, buyers, sellers, and traders may simply have distinct versions of the question form created for the specific implementation which would eliminate the need to have portions of the question form grayed out. The appearance of the columns may be summarized in table 1 where column 1 represents your answer 308, column 2 is preferred replies 310, column 3 is exchanged preferences 312, and column 4 is exchanged answer 313 from another user. X represents a column that is visible to the user when exchanged information is displayed. Unless data from another user is displayed, columns 3 and 4 will also be grayed.

TABLE 1

| | Column 1 | Column 2 | Column 3 | Column 4 |
|---|---|---|---|---|
| | 308/328 | 310/330 | 312/334 | 313/332 |
| Buyer | | X | | X |
| Seller | X | | X | |
| Trader | X | X | X | X |

FIG. 3B depicts an integer question page 320 which by way of example states “Q: How big is it?” 322. As with the multiple choice question page of FIG. 3A, the user may select a symmetry (acquisition 324 or exchange 326), or make no symmetry election (i.e. the user does not select either acquisition 324 or exchange 326). Next, a disposing user inputs an integer representing an appropriate dimension in integer box 327. If an acquiring user has a preferred answer range 330, the user may input integers for a minimum to maximum range 329. Exchanged answer column 332 and exchanged preference column 334 will be grayed out and will not be displayed at this time, but will be used at a later time if a match is made, this specific question was subject to the offer, and information was exchanged. As in FIG. 3A, the user may enter the selections by checking/clicking OK button 336, cancel by checking/clicking cancel button 337, or delete the data entered by checking/clicking delete button 338. As in FIG. 3A, the corresponding columns will be grayed until conditions for presenting these columns are met.

FIG. 3C depicts free form text question page 340 which is used to request specific information. A question such as “Q: What is your email address?” 342 is presented. The user may elect only exchange symmetry 344 or, the user may elect not to chose exchange symmetry, since there may be no preferred answer to such a question. The user's email address would be entered in “Your answer” 346. Exchanged answer 348 would be grayed out at this time and would be used in the event a successful match was made and information exchanged. Additional question types are possible and those shown here are only exemplary. It is expected that this type of question may be used by buyers and sellers, and not just traders, particularly when a point is reached where identity or contact information needs to be exchanged.

FIG. 3D depicts offer filter page 350. Offer filter page 350 is used to assemble a group of questions to be presented as a group of offers by posting to the escrow database. Use of offer filter 350 is similar to the construction of a search specification in other programs. But offer filter 350 also specifies when the owners of matching data can be informed of the information in the user's search specification. From a seller's point of view such buyer information is useful in making decisions regarding the sale as well as providing useful marketing information. Offer filter 350 has three sections: offer summary section 351, required question summary 369 and control section 379. Offer summary section 351 has offered questions column 352, offered replies column 354, preferred column 356, acquisition column 358, and exchange column 360. Offered questions column 352 lists the questions for which the user offers to provide responses if mutuality conditions are met. The offered questions are listed using question designators 362. Question designator 362 is typically a unique designator with a brief description. Each question designator is a hyperlink to the full question page located in the escrow database for further reference. The user has already filled out user responses to each question, indicated user preferred responses, and selected user required symmetries, and these indications may be automatically populated to filter 350 for user convenience. Thus replies 364 lists reply designators, each of which is hyperlink to the full question page showing the reply previously entered by the user. In like manner, symmetry designations, either acquisition or exchange, previously entered by the user are shown by automatically filling in the appropriate check boxes. Required questions section 369 has offered column 352, offered replies column 354 and preferred column 356. In required questions section 369, required questions are listed using required question designators 372. Each required questions designator is a hyperlink to the corresponding question page in the questionnaire database. Reply column 354 lists required question response designators 374. Preferred column 356 serially lists preferred response designators 376 through 378. Each of the columns in offered questions section 351 and in required section 369 are populated from the escrow (questionnaire) database such as database 210 in FIG. 2. Control section 379 has OK buttons 380, cancel button 382, delete button 384, add question button 386, and remove questions 388. Add question button 386 and remove question button 388 may be clicked in order to invoke FIG. 3F and FIG. 3G. If OK 380 is clicked, the selections are saved and posted (or updated). If cancel 382 is clicked, no selections are saved. By hyperlinking on a question designator such as OGI in offered questions 362, the corresponding question form from questionaire database 210 (see FIG. 2) will be displayed. Shading may be used to facilitate use of the display. For example, offered replies column 354 may be grayed for a buyer. Preferred column 356 may be grayed for a seller. Exchange column 360 may be grayed for buyer and seller. The name for offer filter page 350 is the filter name.

FIG. 3E depicts alternate offer filter page 389. Alternate offer filter 389 displays only offered column 352, acquisition 358, and exchange 360 in offered question section 351 and only required questions 372 in required section 369. Control section 379 is the same. OK 380, cancel 382, delete 384, add question 386 and remove question 388 are the same in FIG. 3E as in FIG. 3D. Alternate offer filter page 389 presents only essential information for expressing the offered exchange of information.

FIG. 3F depicts add offered question page 390. Using add question page 390, the user may scroll down a list of questions until a desired question is located. The user may then highlight a desired question, and click OK 394 to add the question to the offer filter along with the selections made for the offered questions and/or required questions. In addition, the user must select offered 392 to designate the selected question as a question for which a response is offered and/or select required 393 to designate the selected question as a question for which a response is required. At least one of offered 392 or required 393 must be checked. Cancel button 395 may be clicked to avoid adding a question. Offered 392 may be grayed if a question such as question has no reply chosen (see FIG. 3D). Required 393 may be grayed if a question has no preferences chosen (see FIG. 3D). If neither a reply nor a preference has been chosen, the question does not appear on the list. Clicking OK 394 or cancel 395 returns the user to the offer filter page 350 (or its alternate 390).

FIG. 3G depicts remove question page 396 with which the user may select a question to remove from the offer filter. The user scrolls down the list of question responses, highlights the desired question response, and clicks OK 398 to remove the question response from the filter, or cancel 399 to ignore the selection. It is possible that a question may appear twice with each appearance having a check in a different column meaning that in one instance it is offered and in another instance it is required so that a review of remove question page 396 allows the user an opportunity to delete one of the instances from the offer filter. As with FIG. 3F, clicking OK 398 or cancel 399 returns to the offer filter page 350 or 390.

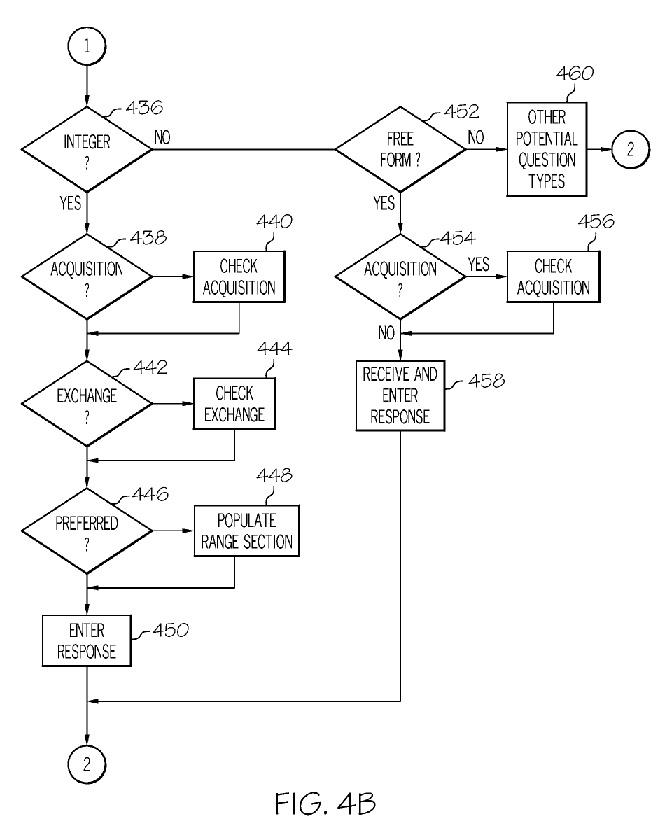

FIG. 4A-4B depicts a flow chart of questionnaire module 400. Questionnaire module 400 starts (402) and accesses the questionnaire database (410). The user selects a category (412) and reviews the list of questions presented (414). The user selects a question (415) and questionnaire module 400 determines whether the selected question is a text question (416). If so, questionnaire module 400 determines whether the user selected acquisition symmetry (418), and if so, questionnaire module 400 un-grays the acquisition symmetry box (420). If the user did not check acquisition symmetry (418), then questionnaire module 400 determines whether the user selected exchange symmetry (422), and if so, exchange symmetry un-grays in the exchange symmetry box (424). Next, questionnaire module 400 determines whether the user has selected “define a new answer” (426). If so, questionnaire module 400 receives the new answer entered by the user (428), and if not, goes to step 430. Next, questionnaire module 400, determines whether the user entered a preferred response to the question (430). If so, questionnaire module 400 receives and enters the preferred response (432), and if not, goes to step 462.

Returning to step 416, if questionnaire module 400 determines that the question is not a text question, then questionnaire module 400 determines whether the question is an integer question (436). If so, questionnaire module 400 determines whether the user has indicated acquisition symmetry (438), and if so, places a check mark in acquisition box (440). If not, questionnaire module 400 determines whether the user has indicated exchange symmetry (442), and if so, places a check mark in exchange box (444). If not, questionnaire module 400 determines whether the user has indicated a preferred range (446) and if so populates the preferred range section (448). Next, questionnaire module 400 receives the response entered by the user (450), and goes to step 460.

Returning to step 436, if questionnaire module 400 determined that the question was not an integer question, then questionnaire module 400 determines whether the question is a free form text question (452). If so, questionnaire module 400 determines whether the user has indicated acquisition symmetry (454), and if so, places a check mark in the acquisition box (456) and goes to step 458. If not, questionnaire module 400 receives and enters the user's response (458), and goes to step 462. At step 462, a determination is made whether the user desires to continue, and if so, questionnaire module 400 goes to step 415. Additional question types would be similarly handled. If not, questionnaire module 400 stops (470).

FIG. 5 depicts a flow chart of offer module 500. Offer module 500 starts (502) when invoked by the user, and the user selects an occasion (504). Examples of an occasion are a travel itinerary for a winter trip, spring trip, fall trip, or summer trip. An additional example would be a person or occasion such as an individual's birthday, a wedding, or the user's wish list. Next, the user selects a category (510). Examples of travel related categories are hotel reservations, airline reservations or automobile reservations. Examples of gift related categories are automotive, television, or stereo. The user enters or selects an offer group filter (512) and offer module 500 displays the offer group (514). The user may have a draft offer filter stored under that category which will be presented first. If a new filter is chosen, then the offer filter group will be empty. The offer group displayed may be offer filter 350 (see FIG. 3D) or alternate offer filter 390 (see FIG. 3E). A determination is made whether the user entered a new filter group name (516). If so, the filter name is updated (518). If not, a determination is made whether the user wants to remove a question (520). If so, FIG. 3G is displayed (522) and a determination is made whether the change is OK (524). If not, the change is canceled and offer module 500 goes to step 514. If the change is OK, the selected question is removed from the filter and offer module 500 goes to step 514. If at step 520, a determination is made that the user did not remove a question, then a determination is made whether the user wants to add a question (528). If the user wants to add a question, FIG. 3F is displayed. A determination is made whether the addition is OK (532). If so, the selected question is added to the filter (534), and if not, offer module 500 goes to step 514. If at step 528, the user did not want to add a question, a determination is made whether the user wants to cancel (536). If so, a determination is made whether the user wants to delete the filter (538). If so, the filter is removed from escrow (540) and offer module 500 stops (550). If the user does not want to delete the filter, a determination is made whether the filter is OK (542). If so, the filter escrow is updated (544), and if not, offer module 500 goes to step 550. If at step 536 the user does not want to cancel, offer module 500 stops (550).

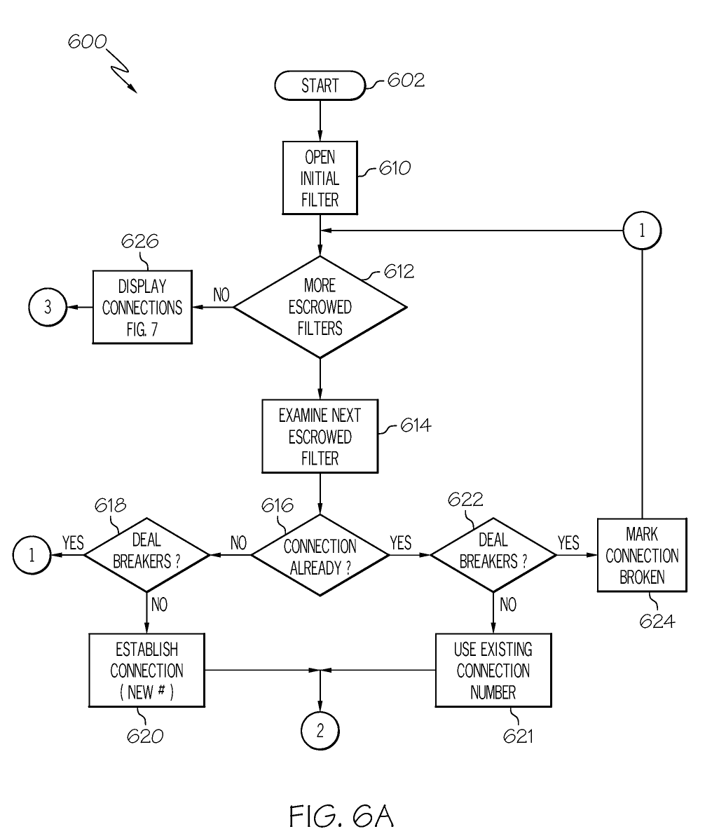

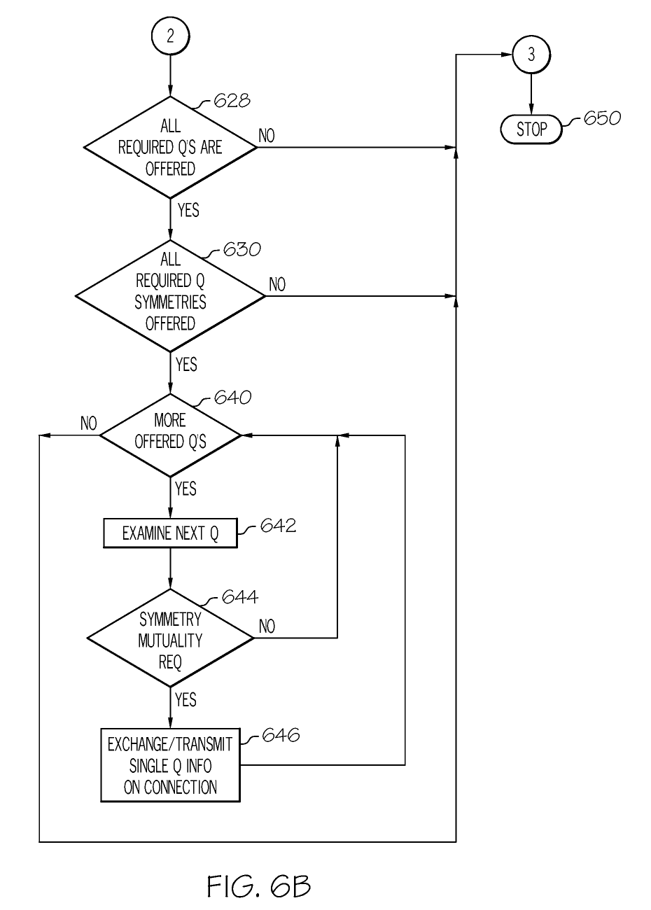

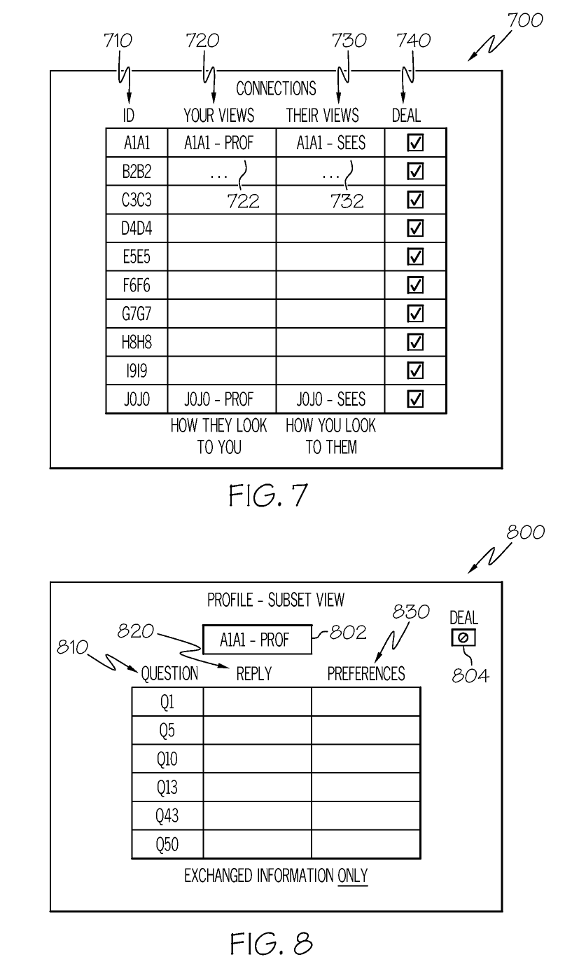

FIG. 6A-6B depict a flow chart of match module 600. Match module 600 starts when the user clicks on a link for the connections page (see FIG. 7) (602) and opens an initial filter (610). The initial filter is used to specify deal breakers required for a connection. Match module 600 determines whether there are more escrowed filters (612). If not, match module 600 displays the connections table (see FIG. 7) (626) and stops (650). If there are more escrowed filters, match module 600 examines the next escrowed filter (614). In steps 612 and 614, match module 600 loops through all escrowed initial filters for other parties with matching category. For example, buyers get matched with sellers and traders get matched with traders for the same type of item. A determination is made whether there is already a connection (616). If there is a connection, a determination is made whether there are deal breakers (622). By deal breaker (at 622 and also at 618) is meant that a potential match does not meet the requirements of the other party to a potential match. If so, match module 600 marks the connection broken (624). A no deal symbol is used to mark the connection broken (see 804, FIG. 8). If not, match module 600 uses the existing connection number (621) and goes to step 628. If the determination at step 616 was that there was no connection, then a determination is made whether there are deal breakers (618). If so, match module 600 goes to step 612. If not, a new connection is established (620). A new connection record is created in the escrow which contains the internal identification of both parties and names for the connection that each party will use (called connection IDs). Match module 600 goes to step 628. At step 628, a determination is made whether all required questions are offered. If not, match module 600 stops (650). If all required questions are offered, then a determination is made whether all required question symmetries are offered (630). For example, if user A required a question, but user B did not offer the question, then user B has not offered the required question symmetry. If not, match module 600 stops (650). If so, a determination is made whether there are more offered questions (640). The determination is based on offered questions in user A's list and user B's list where user A and user B are potential matches. If not, match module 600 stops (650). If so, match module 600 examines the next question (642). A determination is made whether there is a symmetry mutuality requirement (644). For example, if user A offered a question with symmetry, but didn't offer the question, the user A would not meet a mutuality requirement. If not, match module 600 goes to step 640. For example, if user A required a question, user B offered the question, user B required symmetry, but user A didn't offer the question, then the symmetry mutuality requirements have not been met. If so, match module 600 exchanges/transmits single question information on the connection (646). In the alternative, at step 646, rather than transmitting information, an “access right” may be established for that question's information for the other party in the escrow account so that when all requirements are met, information will be transmitted. Match module 600 goes to step 640.

FIG. 7 depicts connections table 700. Viewing this page activates the matching module 600 to refresh the information in this page. Entries in ID column 710, your-view column 720, and their-views column 730 are hyperlinks to profile subset view pages (See FIG. 8). A checkmark in a box in deal column 740 means that there are no deal breakers and the process is ok to continue. A null sign (zero with slash through it) in a box in deal column 740 means that deal breakers were found after the connection was established and therefore, no information can be exchanged. Deal breakers are checked each time the connections table 700 is displayed. Identifier A1A1 is shown in ID Column 710 with link A1A1-Prof in your views column 720 and link A1A1-Sees in Their views column 730.

FIG. 8 depicts exchanged information table 800. By clicking on the entry A1A1-Prof in your views column 720 on connection table 700, AIAI-Prof Profile-subset view 802 is displayed. A1A1 represents the ID on the connection page and the suffix “Prof” is added. The suffix “Prof” means “their” profile information. The suffix “Sees” means “your” profile information. If “no deal” is shown using the null sign (804), then answers to all deal breaker questions are not shown. If “access rights” implementation is used, and as in general, one should not be allowed to see or determine “what broke the deal.”

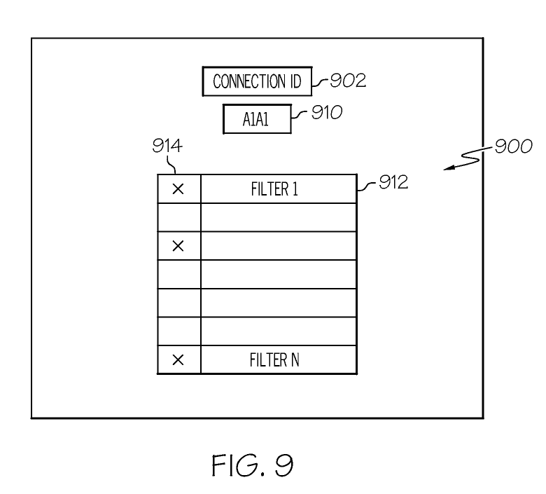

FIG. 9 represents filter table 900. A user may select a filter so indicating in column 914.

Persons skilled in the art will recognize that the computer implemented method disclosed above may be incorporated in a computer program product containing instructions for causing one or more computers to carry out the steps of the method and to display graphical user interfaces such as those disclosed above.

A preferred form of the invention has been shown in the drawings and described above, but variations in the preferred form will be apparent to those skilled in the art. The preceding description is for illustrative purposes only, and the invention should not be construed as limited to the specific form shown and described. The scope of the invention should be limited only by the language of the following claims.

What is claimed:

1. A system for simultaneous information exchange comprising:
a first participant computer and a second participant computer connected to a server;
a storage connected to the server containing an escrow database;
a simultaneous information release application, a questionnaire module, an offer module, and a match module;
wherein a plurality of participants pre-populates the escrow database by accessing a questionnaire database, selecting a category, and providing responses to a plurality of questions for the category;
wherein the match module determines whether a first participant filter and a second participant filter meet mutuality conditions, and responsive to a positive determination, exchanges information between the first participant and the second participant.

2. The system of claim 1 further comprising:
wherein using the questionnaire module, the first participant pre-populates an escrow database with first participant selected questions, first participant responses to the first participant selected questions, and first participant mutuality conditions and a second participant pre-populates the escrow database with second participant selected questions, second participant responses, and second participant mutuality conditions.

3. The system of claim 2 further comprising:
wherein using the offer program, the first participant creates the first participant offer filter and the second participant creates the second participant offer filter.

4. The system of claim 1 wherein questions are accessed by selecting individual questions from a list, and completing a question page for the selected questions.

5. The system of claim 4 wherein the each of the plurality of participants completes a question page by answering the question, indicating response requirements, and indicating preferred responses.

6. The system of claim 4 wherein the each of the plurality of participants completes a question page by answering the question and indicating symmetry requirements.

7. The system of claim 4 wherein the question page comprises multiple choice, integer, and free form text pages.

8. The system of claim 1 wherein an offer filter indicates questions for which a participant offers to provide to each of a plurality of participants a response, and a symmetry requirement, if any, that must be met for mutuality.

9. The system of claim 1 wherein an offer filter presents a plurality of questions that must be answered for mutuality to be met, and further, a plurality of preferred responses that a participant conditions mutuality upon.

10. The system of claim 5 wherein the preferred response is a deal breaker and mutuality is not met.

11. The system of claim 1 wherein, once an offer filter is posted to the escrow database, the match module compares the offer filter to other offer filters in the escrow database, and determines whether there is a match.

12. The system of claim 1 wherein, a pair of offer filters are analyzed for mutuality conditions, and if mutuality conditions are satisfied, then a plurality of responses to a plurality of offered questions are exchanged.

13. A computer implemented process comprising:
pre-populating an escrow database by accessing a questionnaire database, selecting a category, and completing a plurality of questions for the category;
creating an offer filter containing an offered section, a required section and a control section;
posting the offer filter to the escrow database; and
comparing the offer filter to any other offer filters in the escrow database, and determining whether there is a potential match.

14. The computer implemented process of claim 13 further comprising:
accessing questions by selecting individual questions from a list, and then completing a question page for the selected questions;
completing a question page by answering the question, indicating symmetry requirements, response requirements, and preferred responses;
indicating, in the offered section, those questions for which the user offers to provide responses, and the symmetry requirements, if any, that must be met for mutuality;
indicating in the required section, a required question that must be answered for mutuality to be met, and further, a preferred response that the user conditions mutuality upon; and
comparing the offer filter to any other offer filters in the escrow database, and determining whether there is a potential match.

15. The computer implemented process of claim 14 further comprising:
analyzing the pair of offer filters for all mutuality conditions, and if all mutuality conditions are satisfied, exchanging the responses to the offered questions.

16. The computer implemented process of claim 14 further comprising:
creating a deal breaker so that when a response is offered to a required question that has a preferred response, and the response is not the preferred response, mutuality is not met and no exchange takes place.

17. A computer program product comprising:
a computer readable medium containing instructions to cause a computer to perform the following steps:
pre-populating an escrow database by accessing a questionnaire database, selecting a category, and completing a plurality of questions for the category;
accessing questions by selecting individual questions from a list, and then completing a question page for the selected questions;
completing a question page by answering the question, indicating symmetry requirements, response requirements, and preferred responses;
creating an offer filter containing an offered section, a required section and a control section;
indicating, in the offered section, those questions for which the user offers to provide responses, and the symmetry requirements, if any, that must be met for mutuality;
indicating in the required section, a required question that must be answered for mutuality to be met, and further, a preferred response that the user conditions mutuality upon;
posting the offer filter to the escrow database; and
comparing the offer filter to any other offer filters in the escrow database, and determining whether there is a potential match.

18. The computer program product of claim 17 further comprising:
analyzing the pair of offer filters for all mutuality conditions, and if all mutuality conditions are satisfied, exchanging the responses to the offered questions.

19. The computer program product of claim 17 further comprising:
creating a deal breaker so that when a response is offered to a required question that has a preferred response, and the response is not the preferred response, mutuality is not met and no exchange takes place.
